(19) United States
(12) Patent Application Publication
(10) Pub. No.: US 2012/0232956 A1
(43) Pub. Date: Sep. 13, 2012

(54) CUSTOMER INSIGHT SYSTEMS AND METHODS

(75) Inventors: Venkatachari Dilip, Cupertino, CA (US); Arjun Jayaram, Fremont, CA (US); Ian Eslick, San Francisco, CA (US)

(73) Assignee: Compass Labs, Inc., San Jose, CA (US)

(21) Appl. No.: 13/416,937

(22) Filed: Mar. 9, 2012

Related U.S. Application Data
(60) Provisional application No. 61/464,934, filed on Mar. 11, 2011.

(51) Int. Cl. G06Q 30/02

(52) U.S. Cl. 705/7.33; 705/14.45; 705/14.43; 705/7.29; 705/14.66

(57) ABSTRACT

Example systems and methods of identifying customer insights are described. In one implementation, a method generates seed data associated with a likely advertisement audience, and generates sets of interests and demographic clusters based on the seed data. An advertisement campaign is launched based on the sets of interests and the demographic clusters. The demographic clusters are divided into smaller clusters based on advertisement campaign results. The method then identifies interests associated with individuals engaging with specific advertisements.

### RELATED APPLICATION

This application claims the priority benefit of U.S. Provisional Application Ser. No. 61/464,934, entitled “Customer Insight Systems and Methods”, filed Mar. 11, 2011, the disclosure of which is incorporated herein by reference in its entirety.

### TECHNICAL FIELD

The present disclosure generally relates to data processing techniques and, more specifically, to systems and methods for identifying and analyzing customer information.

### BACKGROUND

Interaction among users through online systems and services, such as social media sites, social networks, blogs, microblogs, and the like, is increasing at a rapid rate. These online systems and services provide different forms of content and allow users to share various types of information. Additionally, these systems and services allow users to exchange ideas, stories, comments, pictures, and other information among their friends and acquaintances.

### BRIEF DESCRIPTION OF THE DRAWINGS

Some embodiments are illustrated by way of example and not limitation in the figures of the accompanying drawings.

FIG. 1 is a block diagram illustrating an example environment capable of implementing the systems and methods discussed herein.

FIG. 2 is a block diagram illustrating example sources of information providing data used to obtain customer insights.

FIG. 3 is a flow diagram illustrating an embodiment of a procedure for obtaining customer insights.

FIGS. 4 and 5 illustrate additional details related to an example procedure for obtaining customer insights.

FIG. 6 is a block diagram illustrating an example computing device.

FIGS. 7 and 8 illustrate example customer insight information.

### DETAILED DESCRIPTION

Example systems and methods to identify and analyze customer insights are described. In the following description, for purposes of explanation, numerous specific details are set forth in order to provide a thorough understanding of example embodiments. It will be evident, however, to those skilled in the art that the present invention may be practiced without these specific details.

The systems and methods described herein identify information and characteristics associated with an advertiser's likely audience. The identified information and characteristics may be referred to as “customer insights.” In a particular embodiment, the described systems and methods obtain customer insights based on various information, such as online social interactions, web site demographics, keyword searches, customer purchase history, customer response to particular advertisements, user profile information, and the like. Using the customer insights, an advertiser can better understand their target customer, such as the likes/dislikes of the target customer, where they shop, their favorite television programs, their social media usage patterns, their hobbies, and so forth.

Particular examples discussed herein refer to user communications and/or user interactions via social media web sites/services, microblogging sites/services, blog posts, and other communication systems. Although these examples may mention “social media interaction” and “social media communication”, these examples are provided for purposes of illustration. The systems and methods described herein can be applied to any type of information, interaction or communication for any purpose using any communication mechanism.

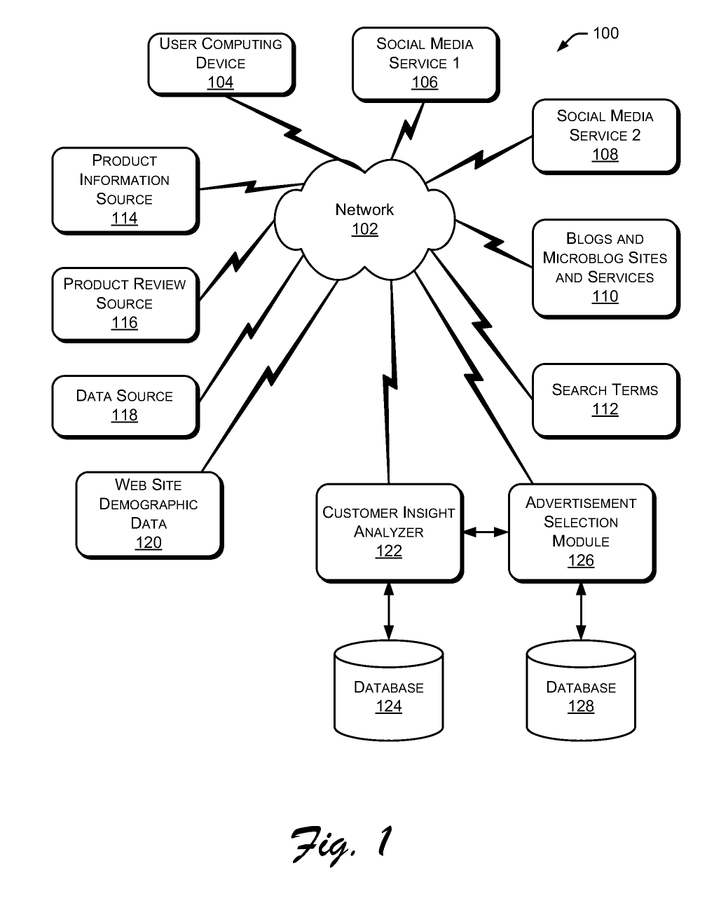

FIG. 1 is a block diagram illustrating an example environment 100 capable of implementing the systems and methods discussed herein. A data communication network 102, such as the Internet, communicates data among a variety of Internet-based devices, Web servers, data sources, and so forth. Data communication network 102 may be a combination of two or more networks communicating data using various communication protocols and any communication medium.

The embodiment of FIG. 1 includes a user computing device 104, social media services 106 and 108, one or more blog/microblog sites and services 110, one or more search terms (and related web browser applications/systems) 112, a product information source 114, a product review source 116, a data source 118, and a source for web site demographic data 120. Environment 100 also includes a customer insight analyzer 122, an advertisement selection module 126, and two databases 124 and 128. Database 124 is accessible by customer insight analyzer 122. Database 128 is accessible by advertisement selection module 126. Although customer insight analyzer 122 and advertisement selection module 126 are shown in FIG. 1 as separate components or separate devices, in particular implementations these components can be combined into a single device or system. In a particular embodiment, customer insight analyzer 122, advertisement selection module 126 and databases 124 and 128 are contained in a web-based server coupled to data communication network 102.

User computing device 104 is any computing device capable of communicating with data communication network 102. Examples of user computing device 104 include a desktop or laptop computer, handheld computer, tablet computer, cellular phone, smart phone, personal digital assistant (PDA), portable gaming device, set-top box, and the like. Social media services 106 and 108 include any service that provides or supports social interaction and/or communication among multiple users. Example social media services include Facebook®, Twitter® (and other microblogging web sites and services), MySpace®, message systems, online discussion forums, and so forth. Blogs and microblog sites and services 110 contain various information, such as postings, articles, comments, announcements, and the like. Search terms 112 include various search queries (e.g., words and phrases) entered by users into a search engine, web browser application, or other system to search for content (e.g., web-based content or product information) via data communication network 102.

Product information source 114 is any web site or other source of product information accessible via data communication network 102. Product information sources 114 include manufacturer web sites, magazine web sites, news-related web sites, and the like. Product review source 116 includes web sites and other sources of product (or service) reviews, such as Epinions^{SM} and other web sites that provide product-specific reviews, industry-specific reviews, and product category-specific reviews. Data source 118 is any data source that provides any type of information related to one or more products, services, manufacturers, evaluations, reviews, surveys, events, and so forth. Although FIG. 1 displays specific services and data sources, a particular environment 100 may include any number of social media services 106 and 108, blog/microblog sites and services 110, search terms 112 (and search term generation applications/services), product information sources 114, product review sources 116, data sources 118, and web site demographic data 120. Additionally, specific implementations of environment 100 may include any number of user computing devices 104 accessing these services and data sources via data communication network 102.

Customer insight analyzer 122 performs various procedures and operations to develop customer insights for the benefit of advertisers and other users or entities. Advertisement selection module 126 selects one or more advertisements for a particular user (or category/group of users) based on customer insights obtained by customer insight analyzer 122, as discussed herein.

Database 124 stores various customer insight information, communication information, topic information, intent information, response data, and other information generated by and/or used by customer insight analyzer 122. Database 128 stores various information related to advertisements and other data used by advertisement selection module 126.

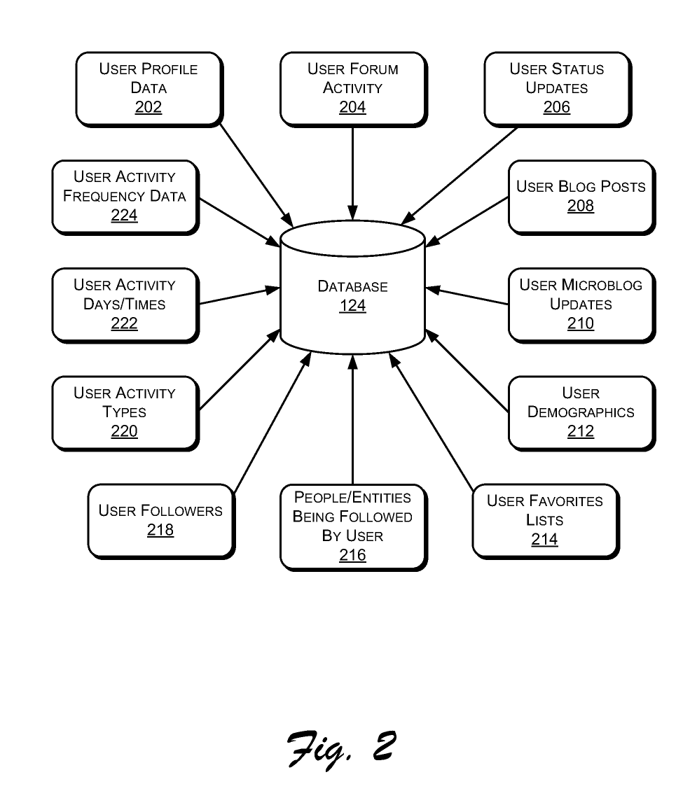

FIG. 2 is a block diagram illustrating example sources of information providing data used to obtain customer insights. The user data from multiple sources is collected and stored, for example, in database 124. The data may be collected and/or processed by any number of devices prior to being stored in database 124. For example the data can be processed by customer insight analyzer 122 prior to storage in database 124.

As shown in FIG. 2, received data includes user profile data 202 received from one or more sources, such as online data sources, social media web sites, and so forth. Additional data regarding user interests and user activities is received from user activity forums 204 (or other online forums) in which users post comments, view information and monitor various discussions. Additional user information is obtained from user status updates 206, such as social media communications and other online communications. User blog posts 208 and user microblog updates 210 also provide information regarding a user's interests and activities. User demographics 212 are useful in identifying information about the user and predicting interests, activity levels, and the like.

Information about users is also received from user favorites lists 214, such as lists of favorite web sites, favorite online discussions, subscriptions to various email lists, social media sites visited, and other information sources. Data about users is also obtained based on the people, groups, or entities 216 being followed by the user, such as the people, groups, or entities being followed through various online social media services. Additionally, user information is obtained regarding the people, groups, or entities 218 following the user. These followers tend to show topics with which the user has significant experience or knowledge.

FIG. 2 also shows that additional data received about a user includes user activity types 220 and user activity days/times 222. User activity types 220 include the most common types of communications, such as blog posts, re-posting of information, social media communications, and so forth. User activity days/times 222 identifies the days and times during which the user is most active in online activities, such as online social interactions, reading online information, posting online information, and the like. User activity frequency data 224 includes information regarding how often a particular user accesses a specific online service, generates an online social communication, performs an activity associated with a particular topic, and so forth. The information received from the sources shown in FIG. 2 is typically received from multiple sources over a period of time. In a particular embodiment, this receiving of information continues on a regular basis, such that the information stored in database 124 is updated on a continual basis.

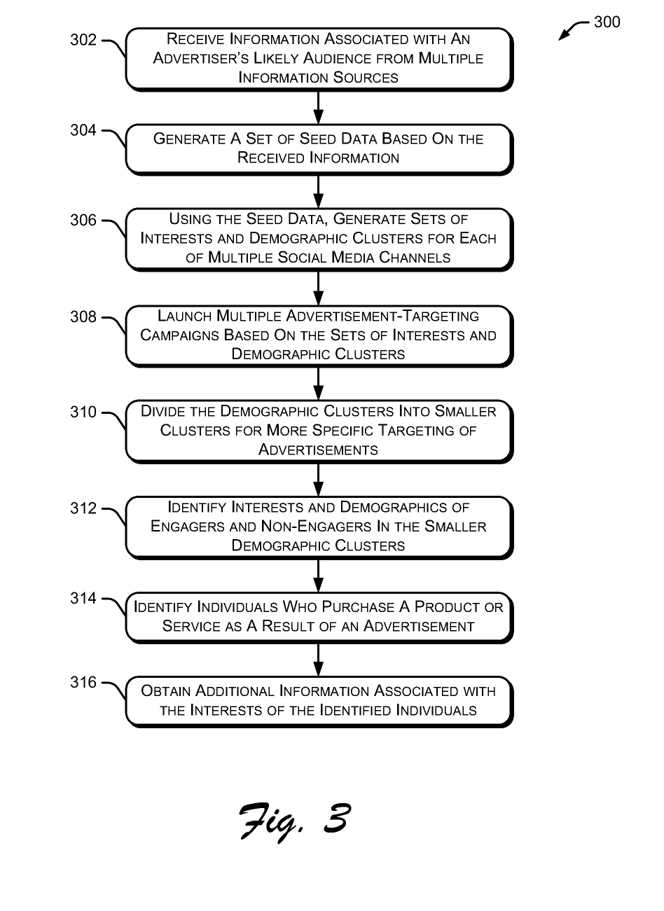

FIG. 3 is a flow diagram illustrating an embodiment of a procedure 300 for obtaining customer insights. Initially, procedure 300 receives information associated with an advertiser's likely audience from multiple information sources at 302. For example, the procedure may access publicly available information from various sources to identify likely customers that use (or are interested in) a particular product or service. The procedure continues by generating a set of seed data based on the received information at 304. This seed information is used to generate sets of interests and demographic clusters for each of multiple social media channels at 306. Demographic clusters are groups of users with similar attributes or characteristics. Demographic clusters could be based on geography, lifestyle, interests, purchase intent, behavior, age or gender, or any combination of these characteristics. An example of a demographic-targeted ad would be women who live in the Western United States between the ages of 31-55. Similarly, a segment of similar users could emerge with the following likes: gym, gymnastics, gym class, gymboree, gymnastic, gym tanning, gymboree deals, gymnasium, gymnastics coach, gym tanning laundry, gymbomama, gym rat, gymkhana grid, gym gymnastics, gymnastics instructor, gymbogirls, which are likely to be associated with people who have an interest in fitness. This represents an example of a set of interests.

Procedure 300 then launches multiple advertisement-targeting campaigns based on the sets of interests and demographic clusters at 308. As the advertisement-targeting campaigns progress, the demographic clusters are divided into smaller clusters for more specific targeting of advertisements at 310.

The procedure continues by identifying interests and demographics associated with engagers (e.g., individuals who responded to an advertisement) and non-engagers (e.g., individuals who did not respond to an advertisement) in the smaller demographic clusters at 312. Procedure 300 then identifies individuals who purchase a product or service as a result of an advertisement (e.g., engagers that went on to purchase the product or service in the advertisement to which they responded) at 314. Finally, the procedure obtains additional information associated with the interests of the identified individuals at 316 to obtain more detailed customer insights.

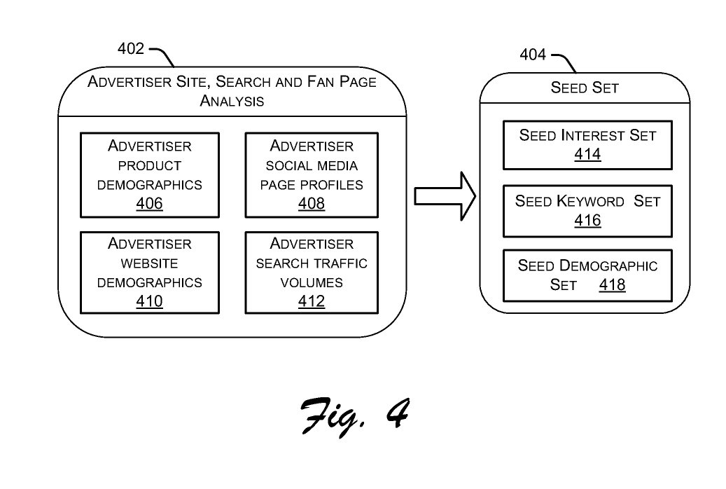

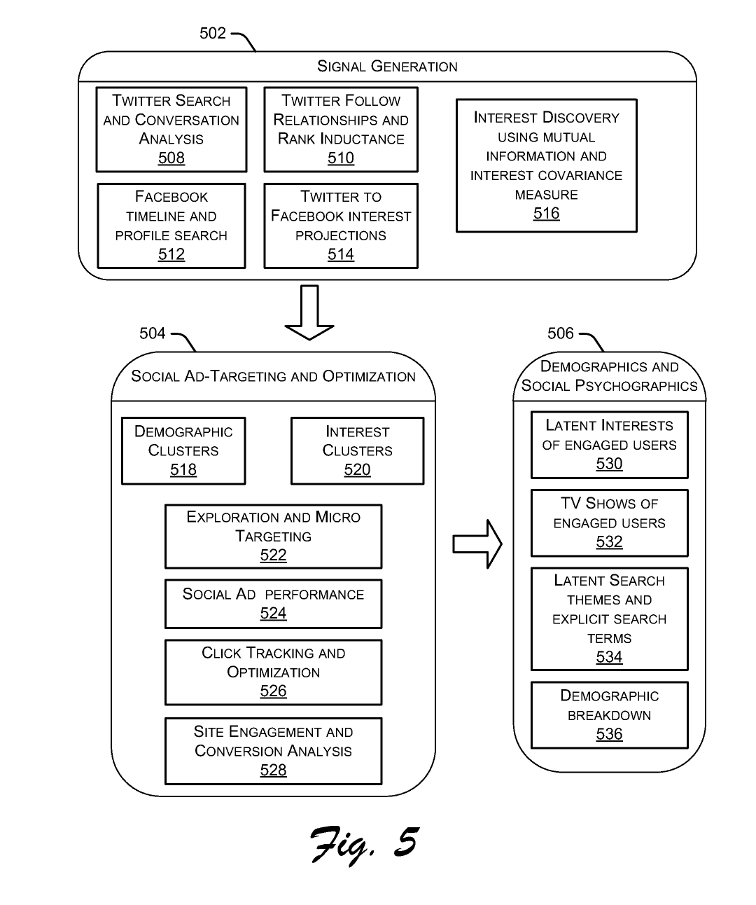

FIGS. 4 and 5 illustrate additional details related to an example procedure for obtaining customer insights. A first step in the procedure involves identifying various information about the advertiser's likely audience. This step is labeled as “Advertiser Site, Search and Fan Page Analysis” in FIG. 4, and identified by reference numeral 402. This step generates a starting set of data (the “Seed Set”) for initiating the procedure that identifies customer insights. Example information identified in this step includes publicly available information about the advertiser's web site demographics 410, which identifies the type of people who use the advertiser's product or service. Additionally, the procedure may analyze advertiser product demographics 406, advertiser social media page profiles 408, and advertiser search traffic volumes 412. The procedure may also consider web site demographics for competitors' web sites or companies that offer complementary products/services. This step also identifies information related to search terms (e.g., provided to a search engine) and keywords used by individuals to discover similar products. Any other publicly available information or intuitive information is also identified. Intuitive information may include likely interests of people who want the advertiser's product/service. For example, if the advertiser's products are running shoes, intuitive information may include terms/topics such as “sports”, “fitness”, “athletics”, “running”, “marathon”, “triathlon”, and so forth.

The various information identified are organized into one or more sets of data. As shown in FIG. 4, a seed set 404 includes a seed interest set 414, a seed keyword (or search term) set 416, and a seed demographic set 418. The seed set 404 shown in FIG. 4 is used by a “Signal Generation” step 502 shown in FIG. 5. The signal generation step 502 uses the seed set 404 to further refine the data and develop a more focused (e.g., finer) set of social media interests, likes, TV shows, sports interests, and so forth. This refinement of the seed data is performed for each social media channel independently. A social media channel may also be referred to as a social media site or social media service, such as Twitter®, Facebook®, and the like.

For each social media channel, the signal generation step queries social media sites, such as Twitter® and Facebook®, using the seed data (e.g., interests, keywords, and demographics). Additionally, from timelines and publicly available profile information, the system identifies more detailed information on the demographics (e.g., city and state), specific interests (e.g., sports, restaurants, and TV shows), and implicit topics of interest (e.g., friends, follows, re-tweets, likes, fans, replies, and conversation initiation). Examples of timelines and publicly available profile information include user posts, messages, links, related posts, related messages, and descriptive information provided by users about themselves.

Using the search words, interests, and likes, the procedure can identify related likes and interests using mutual information and covariance. In a particular embodiment, messages and other information are filtered to get good examples for a given language and platform. The examples are then organized into units at a message or user level based on, for example, term mentions. Next, seed phrases are identified that identify a set of units that represent users or message expression of interest in a particular topic. Once the set of units is identified, the process looks for terms that occur frequently in that set but not as frequently in other sets or in the rest of the units. For example, such terms may have high mutual-information with the seed set.

In some embodiments, signal generation step 502 performs Twitter® search and conversion analysis 508 and identifies Twitter® follow relationships and rank inductance 510. Further, signal generation step 502 may perform a Facebook® timeline and profile search 512 and identify Twitter®-to-Facebook® interest projections 514. A variety of information is used to perform interest discovery using mutual information and interest covariance measures 516.

When signals are sparse, the process can identify additional details using cross-media normalization, such as normalizing Twitter® communications with Facebook® likes. Normalizing includes, for example, the removal of noise such that the statistics of term distribution is similar across large sets of messages across different platforms. After the above-mentioned additional details are identified, the results are grouped into a set of interests and demographic clusters. The set of interests and demographic clusters are provided as input to an advertisement-targeting and optimization engine/procedure, shown in FIG. 5 as “Social Ad-Targeting and Optimization” 504.

Social ad-targeting and optimization includes starting multiple ad-targeting campaigns. These campaigns are “micro-targeted” to find a particular market/product segment that is performing or not performing. Micro-targeting refers to the process of continuously narrowing targets based on performance and/or other attributes. For example, given a set of terms that are good to target, if they perform well they can be broken into smaller sets (e.g., clustering based on term similarity, historical performance, and the like). The smaller sets (also referred to as subsets) are then compared and contrasted to find the best performing subset. Example clustering of data includes demographic clusters 518 and interest clusters 520.

In the social ad-targeting and optimization process 504, the market/product segments that are performing or not performing are broken into smaller clusters to provide a more focused (e.g., fine-grained) targeting. For example, the procedure gathers information related to the advertisements and audience that clicked on the advertisements and landed on the destination site (e.g., the advertiser's web site promoting the advertised product or service). The procedure also collects information regarding an individual's engagement with social advertisements, such as likes, friends, shares, and so forth. Based on the destination site, the procedure gathers more information regarding the type of engagement (e.g., like searches, page views, bounce rates, and final conversions into a sale of the advertised product or service). Bounce rates refer, for example, to a percentage of web site visitors who visit a site but then leave the site instead of continuing to view other pages in the same web site. In the example of FIG. 5, social ad-targeting and optimization engine/procedure 504 includes exploration and micro-targeting 522, social ad performance 524, click tracking and optimization 526, and site engagement and conversion analysis 528.

The information identified and gathered by the social ad-targeting and optimization engine/procedure 504 is provided to a data analysis engine (e.g., Demographics and Social Psychographics engine 506) that identifies latent interests of the users from the information. Example data includes latent interests of engaged users 530 that are not explicitly expressed in user profiles and TV shows 532 they like or talk about. Using entity extraction procedures, the system is able to identify typical search terms that these users are likely to use. These search terms may be used by the advertisers to better position their advertisements to be seen by their target audience. The data analysis engine can also provide a detailed demographic breakdown 536 and a performance matrix of each demographic. Further, the data analysis engine identifies latent search themes and explicit search terms 534. Additional data includes social media usage patterns, such as how much time a user spends at the social media site, and how often they visit the site. Further, the data includes social media data regarding when individuals use social media sites and the type of information they share (e.g., news, videos and web links). These various social media data are useful to advertisers in presenting their advertisements in a manner that is most likely to attract their desired customers.

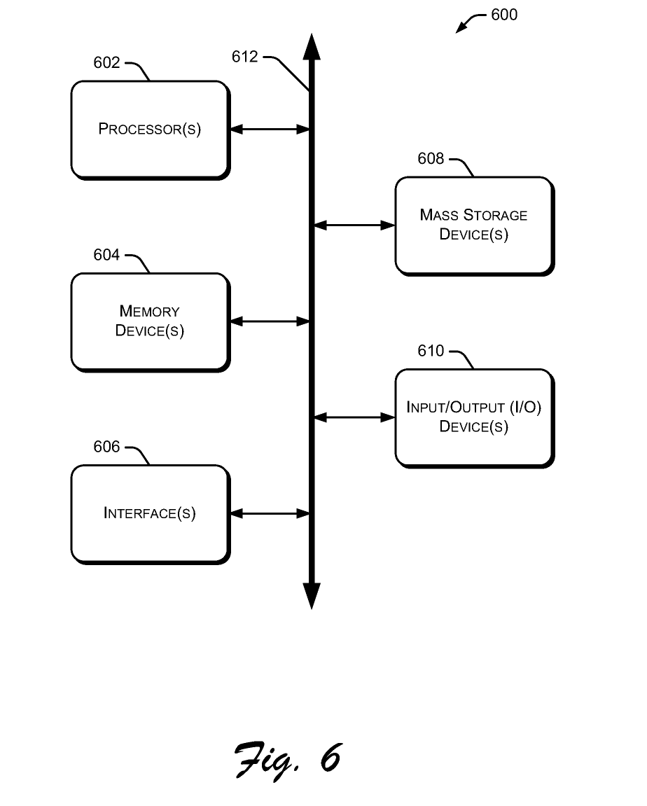

FIG. 6 is a block diagram illustrating an example computing device 600. Computing device 600 may be used to perform various procedures, such as those discussed herein. Computing device 600 can function as a server, a client, or any other computing entity. Computing device 600 can be any of a wide variety of computing devices, such as a desktop computer, a notebook computer, a tablet computer, a server computer, a handheld computer, a smart phone, and the like.

Computing device 600 includes one or more processor(s) 602, one or more memory device(s) 604, one or more interface(s) 606, one or more mass storage device(s) 608, and one or more Input/Output (I/O) device(s) 610, all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM)) and/or nonvolatile memory (e.g., read-only memory (ROM)). Memory device(s) 604 may also include rewritable ROM, such as Flash memory.

Mass storage device(s) 608 include various computer readable media, such as magnetic tapes, magnetic disks, optical disks, solid state memory (e.g., Flash memory), and so forth. Various drives may also be included in mass storage device(s) 608 to enable reading from and/or writing to the various computer readable media. Mass storage device(s) 608 include removable media and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, charge-coupled devices (CCDs) or other image capture devices, and the like.

Interface(s) 606 include various interfaces that allow computing device 600 to interact with other systems, devices, or computing environments. Example interface(s) 606 include any number of different network interfaces, such as interfaces to local area networks (LANs), wide area networks (WANs), wireless networks, and the Internet.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, Peripheral Component Interconnect (PCI) bus, IEEE 1394 (“Firewire”) bus, Universal Serial Bus (USB), and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application-specific integrated circuits (ASICs) can be programmed to carry out one or more of the systems and procedures described herein.

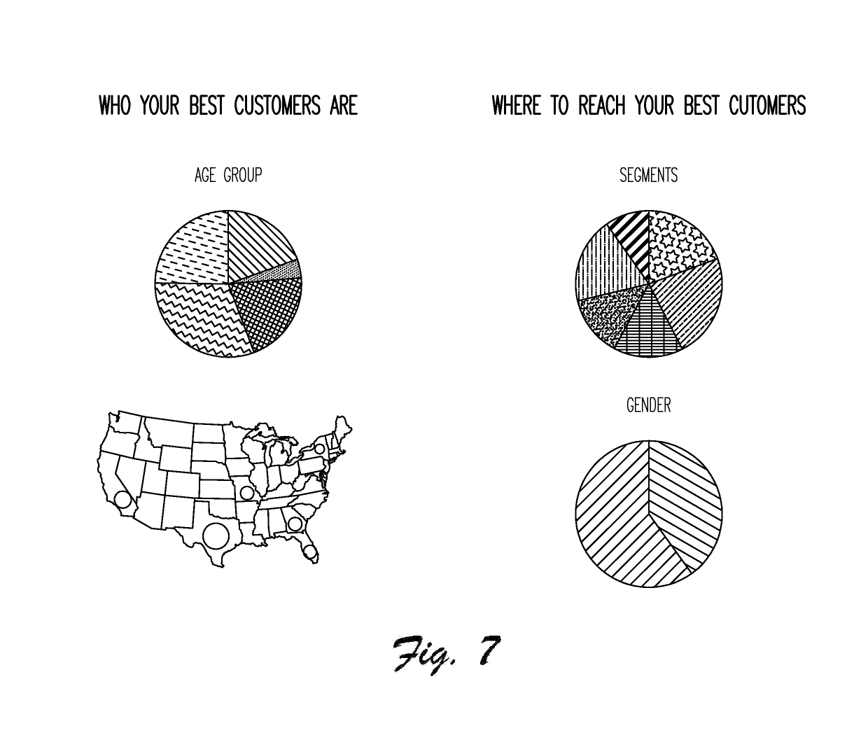

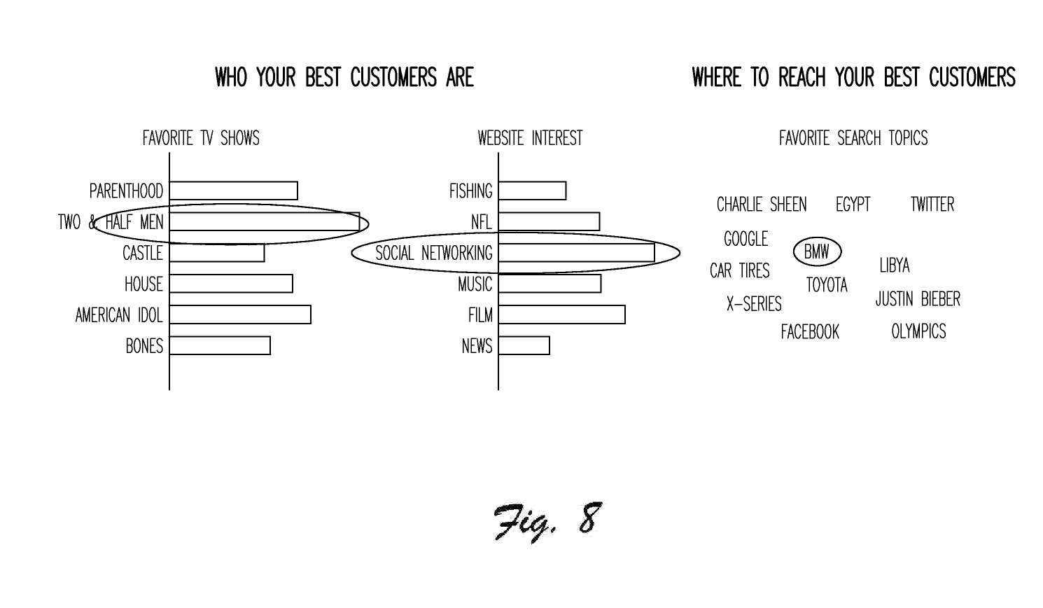

FIGS. 7 and 8 illustrate example customer insight information. For example, FIG. 7 shows breakdowns of customer age groups, geographic locations, market segments, and gender. FIG. 8 shows additional customer insights, such as favorite TV shows, website interests, and favorite search topics. This customer insight information is useful, for example, in targeting advertisements to customers and potential customers.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

What is claimed is:

1. A method comprising:
generating seed data associated with a likely advertisement audience;
generating, using one or more processors, sets of interests and demographic clusters based on the seed data;
launching an advertisement campaign based on the sets of interests and demographic clusters;
dividing the demographic clusters into smaller clusters based on advertisement campaign results, the smaller clusters associated with specific targeting of advertisements; and
identifying interests associated with individuals engaging with specific advertisements.

2. A method as recited in claim 1, further comprising identifying demographic information associated with individuals engaging with specific advertisements.

3. A method as recited in claim 1, further comprising:
identifying individuals purchasing an advertised product as a result of an advertisement; and
obtaining additional information about interests of the identified individuals.

4. A method as recited in claim 1, the seed data associated with a likely advertisement audience includes at least one of interests, keywords, and demographic information.

5. A method as recited in claim 1, the generating of sets of interests and demographic clusters includes applying the seed data to at least one social media web site.

6. A method as recited in claim 4, the applying of the seed data to at least one social media web site includes identifying a plurality of social media relationships.

7. A method as recited in claim 1, the generating of sets of interests and demographic clusters includes applying the seed data to a plurality of social media web sites and normalizing the results from the plurality of social media web sites.

8. A method as recited in claim 1, the identified interests including social media interests.

9. A method as recited in claim 1, the identified interests including at least one of favorite television shows, favorite sports, and favorite hobbies.

10. A method as recited in claim 1, the identified interests including bounce rates associated with individuals who respond to specific advertisements.

11. A method as recited in claim 1, the identifying of interests includes identifying final conversions into a sale by individuals who respond to specific advertisements.

12. A method as recited in claim 1, further comprising identifying typical search terms used by the likely advertisement audience for use in targeting future advertisements.

13. A method as recited in claim 1, further comprising determining social media usage patterns associated with the likely advertisement audience for use in targeting future advertisements.

14. An apparatus comprising:
a memory to store data associated with a plurality of individuals; and
one or more processors coupled to the memory, the one or more processors configured to:
generate seed data associated with a likely advertisement audience;
generate sets of interests based on the seed data;
launch an advertisement campaign based on the sets of interests;
divide the sets of interests into smaller clusters based on advertisement campaign results, the smaller clusters associated with specific targeting of advertisements; and
identify interests associated with individuals engaging with specific advertisements.

15. The apparatus of claim 14, the one or more processors further configured to identify demographic information associated with individuals engaging with specific advertisements.

16. A method comprising:
defining an audience having a plurality of users, wherein the users are associated with at least one online social media service;
identifying online social behavior associated with the plurality of users in the audience based on interaction of the plurality of users with the at least one social media service; and
determining, using one or more processors, audience insights for the audience based on the identified online social behavior.

17. The method of claim 16, the determining audience insights including identifying user interests associated with the plurality of users in the audience.

18. The method of claim 16, the determining audience insights including identifying at least one social engagement activity associated with the plurality of users in the audience.

19. The method of claim 16, the determining audience insights including identifying common demographic characteristics across the audience.

20. The method of claim 16, further comprising generating an advertisement campaign based on the audience insights.
